(19) United States
(12) Patent Application Publication
(10) Pub. No.: US 2007/0180461 A1
(43) Pub. Date: Aug. 2, 2007

(54) Multiplexed Telecommunication and Commerce Exchange Multimedia Tool

(75) Inventor: Antony A. Hilton, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: ICE, L.L.C.

(21) Appl. No.: 11/466,705

(22) Filed: Aug. 23, 2006

Related U.S. Application Data
(60) Provisional application No. 60/764,952, filed on Feb. 2, 2006.

(51) Int. Cl. H04N 7/173; H04N 5/445; H04N 7/16; G06F 3/00; G06F 13/00

(52) U.S. Cl. 725/25; 725/60; 725/102; 725/135

(57) ABSTRACT

A method and system for providing interactive media content are disclosed. In one embodiment, the method comprises receiving an integrated video content. The integrated video content comprises an identification tag. The identification tag is extracted from the integrated video content. Content information associated with the integrated video content is accessed based on the identification tag. The content information and the integrated video content are then rendered to a user.

### PRIORITY

The present application claims the benefit of and priority to U.S. Provisional Patent Application No. 60/764,952 entitled “Multiplexed Telecommunication and Commerce Exchange Multimedia Tool” and filed on Feb. 2, 2006, and is hereby, incorporated by reference.

### FIELD OF THE INVENTION

The field of the invention relates generally to interactive television and more particularly relates to a method and system for distributing interactive video contents.

### BACKGROUND OF THE INVENTION

In general, interactive television (“iTV”) combines the capabilities and services of the Internet with television. Interactive television has many different features, such as electronic program guides (e.g., a display that lists the scheduling of television shows and provides information regarding broadcast stations), content (e.g., a television show), interactive gaming, general information (e.g., news), electronic mail services, Internet browser capabilities, video-on-demand, television-based commerce (“T-commerce”) services, etc. These features are contained within a technology model called a “walled garden.”

Walled gardens, in particular T-commerce, are typically distributed by multi-service organizations such as cable companies or satellite companies. Traditionally, walled garden platforms have been designed and implemented to be a closed communication system. Specifically, walled garden platforms are usually distributed through a multi-service organization's own content delivery system (e.g., digital cable or satellite). Under this model, in contrast to the Internet where users can communicate with each other via multiplexed and centralized forums, walled gardens permit a singular, two-way communications portal between a multi-service organization to a user or from a user to a multi-service organization. Most of the walled garden content, including T-commerce data, is stored within the broadcast/transmission receivers (e.g. set-top boxes) distributed by a multi-service organization. Multi-service organizations update the walled garden content via digital broadcast. The updates may be provided from a database server within a multi-service organization's facility or from a contracted developer's database within the multi-service organization's infrastructure.

Typically, iTV data is compressed into a digital format (e.g., moving picture experts group (“MPEG”)) and transmitted through a multi-service organization's infrastructure to a user's broadcast/transmission receiver. The receiver's software then un-compresses the data and provides or displays the iTV content to the user. With respect to T-commerce data, interactive advertisements are also stored in the broadcast/transmission receiver.

The amount of iTV data compressed into digital format is large. Thus, traditional analog distribution systems do not have the storage available to support iTV. The large size of iTV data is also why data is stored in the user's broadcast/transmission receiver instead of continuously being broadcasted to the receiver. Continuously updating the necessary iTV data through digital broadcast would burden the bandwidth needed for the distribution of normal television services.

In addition, a given walled garden platform is usually developed to be proprietary to a specific multi-service organization. Thus, no two walled garden systems can communicate with one another. The proprietary nature of walled garden systems limits the extent to which T-commerce services can be distributed to various markets and causes advertisers and product makers to incur greater expenses. Because there is no standard walled garden platform upon which T-commerce services can be implemented to obtain full market penetration, there are multiple requirements for an advertiser or product maker to implement an interactive advertisement. This discourages advertisers and product makers from adopting interactive advertising because they need to adopt multiple walled garden services' requirements to reach a wide range of iTV platforms and users. Because an advertiser or product maker needs to produce a new interactive advertisement for each walled garden platform, the cost to provide interactive advertising may be prohibitively large. In addition, since digital services are the main methods through which walled garden services are distributed, iTV services may not be available to users who do not subscribe to digital services.

Furthermore, walled gardens produce limited results from interactive advertising because iTV presently has not achieved full market distribution. Only subscribers to the specific walled garden system have access to interactive advertising, and there is not many walled garden systems in the market to provide interactive advertising environments.

### SUMMARY

A method and system for providing interactive media content are disclosed. In one embodiment, the method comprises receiving an integrated video content. The integrated video content comprises an identification tag. The identification tag is extracted from the integrated video content. Content information associated with the integrated video content is accessed based on the identification tag. The content information and the integrated video content are then rendered to a user.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates a block diagram of an exemplary interactive network including an interactive module, according to one embodiment of the present invention.

FIG. 2 illustrates a block diagram of an exemplary interactive module according to one embodiment of the invention.

FIG. 3 illustrates a block diagram of an exemplary identification tag generation module configured to generate an identification tag, according to one embodiment of the present invention.

FIG. 4 illustrates a block diagram of an exemplary integration module configured to integrate video content with an identification tag, according to one embodiment of the present invention.

FIG. 5 illustrates a block diagram of a duplication module configured to reproduce integrated video content, according to one embodiment of the present invention.

FIG. 6 illustrates a flow diagram of an exemplary process of providing interactive media content to a user, according to one embodiment.

FIG. 7 illustrates an exemplary computer architecture for use with the present system, according to one embodiment.

### DETAILED DESCRIPTION

A method and system for providing interactive media content are disclosed. In one embodiment, the method comprises receiving an integrated video content. The integrated video content comprises an identification tag. The identification tag is extracted from the integrated video content. Content information associated with the integrated video content is accessed based on the identification tag. The content information and the integrated video content are then rendered to a user.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer or other electronics hardware selectively activated or reconfigured by a program stored in the computer or other electronics hardware. Such a program may be stored in a computer or other electronic hardware readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

According to one embodiment, the following terms may have the following meanings without regard to its upper or lower case usage. However, one of ordinary skill would understand that additional embodiments may contemplate additional terms and/or variation of these terms.

“Analog conversion module” may mean any combination of software, firmware, and/or hardware that converts the digital form of master integrated video content into its corresponding analog representation.

“Analog tag generation module” may mean any combination of software, firmware, and/or hardware that generates an analog identification tag.

“Analog video integration module” may mean any combination of software, firmware, and/or hardware that integrates analog video content with an analog identification tag to generate master integrated video content.

“Buffer module” may mean any combination of software, firmware, and/or hardware that stores an identification tag extracted from integrated video content.

“Commerce module” may mean any combination of software, firmware, and/or hardware that receives order information from an interactive module and routes the order information to an appropriate seller for completing a purchase transaction.

“Content database” may mean any combination of software, firmware, and/or hardware that stores content information associated with integrated video content.

“Digital conversion module” may mean any combination of software, firmware, and/or hardware that converts the analog form of master integrated video content into its corresponding digital representation.

“Digital tag generation module” may mean any combination of software, firmware, and/or hardware that generates a digital identification tag.

“Digital video integration module” may mean any combination of software, firmware, and/or hardware that integrates digital video content with a digital identification tag to generate master integrated video content.

“Duplication module” may mean any combination of software, firmware, and/or hardware that reproduces master integrated video content into one or more integrated video contents comprising the same identification tag as the master integrated video content.

“Extraction module” may mean any combination of software, firmware, and/or hardware that scans integrated video content and extracts an identification tag from the integrated video content.

“Identification tag” may mean an identifier assigned to a particular piece of video content.

“Identification tag generation module” may mean any combination of software, firmware, and/or hardware that generates an identification tag.

“Integrated video content” may mean any video content integrated with an identification tag.

“Integration module” may mean any combination of software, firmware, and/or hardware that integrates video content with an identification tag to generate master integrated video content.

“Interactive module” may mean any combination of software, firmware, and/or hardware that renders integrated video content to a user.

“Payment database” may mean any combination of software, firmware, and/or hardware that stores payment information and/or shipping information of a user.

“Rendering module” may mean any combination of software, firmware, and/or hardware that renders integrated video content and its associated content information to a user.

“Request communications module” may mean any combination of software, firmware, and/or hardware that accesses an identification tag stored in a buffer module and transmits the identification tag to a content database.

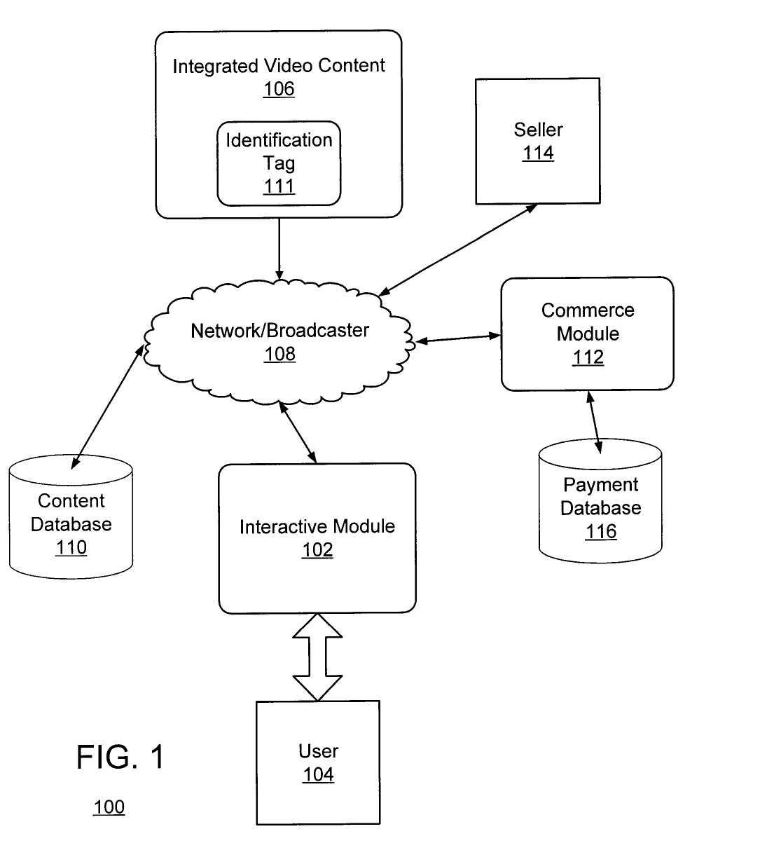

FIGS. 1-5 illustrate block diagrams of an exemplary interactive media system, according to embodiments of the present invention. In addition to interactive media systems, it is to be appreciated that other systems employing the various teachings herein may also be used to practice the various aspects of the present invention, and as such, are considered to be within its full scope.

FIG. 1 illustrates a block diagram of an exemplary interactive network 100 including an interactive module 102, according to one embodiment of the present invention. Interactive module 102 may be software, firmware, and/or hardware or any combination of software, firmware, and/or hardware. In one embodiment of the invention, interactive module 102 is located on or coupled to a hardware configured to render digital or analog video content to a user 104. For example, the hardware may be a computer system, handheld device such as personal digital assistant or cellular phone, digital or analog television, video cassette recorder or player, video compact disc (“VCD”) player, digital versatile disc (“DVD”) player, digital video recorder (“DVR”), broadcast/transmission receiver, and set-top box. The hardware may also consist of a display such as a liquid crystal display (“LCD”), plasma display, and cathode ray tube (“CRT”) display.

As shown in FIG. 1, interactive module 102 receives integrated video content 106 via a network/broadcaster 108. Integrated video content 106 may be a television show, movie, commercial, or any other video content. Network/broadcaster 108 may be a local area network (“LAN”), wide area network (“WAN”) such as the Internet, virtual private network (“VPN”), wireless network, cable network, satellite network, cable service provider, satellite service provider, or other network that is configured to transmit digital or analog data to interactive module 102. Network/broadcaster 108 may also be a secure communications channel such as secure sockets layer (“SSL”) Internet connection. In another embodiment of the invention, interactive module 102 receives integrated video content 106 via other means such as over the air transmission or physical media (e.g., video cassettes, DVDs, VCDs, DVRs, etc.).

According to one embodiment of the invention, interactive module 102 renders integrated video content 106 via the associated hardware. Integrated video content 106 may be rendered to user 104 in analog form (e.g., over the air broadcast or video cassettes) or in digital form (e.g., digital air broadcasts, DVD, streaming video, digital satellite, digital cable, etc.). In addition, interactive module 102 renders a menu browser to user 104 via the hardware. The menu browser may be rendered to user 104 in various ways. For example, the active video screen of integrated video content 106 can be PIPed (picture in picture) where the active video (e.g., film or television show) is made smaller to allow the menu browser to fit on the screen. Alternatively, the menu browser pops up as an overlying window that is made translucent so that the active video background can continue to be better observed by user 104.

Each integrated video content 106 has an associated content information stored in a content database 110. Each integrated video content 106 contains a unique identification tag 111. In response to receiving integrated video content 106, interactive module 102 extracts identification tag 111 from integrated video content 106 and transmits the identification tag 111 to content database 110 (e.g., via network/broadcaster 108). Using identification tag 111, content database 110 extracts the content information associated with integrated video content 106 and transmits the associated content information to interactive module 102. Interactive module 102 is configured to render the associated content information to user 104 (e.g., along with integrated video content 106). The content information includes, without limitation, information regarding the particular television programming being rendered to user 104 (e.g., brief synopsis of the movie or show, its cast, etc.), a list of products that are associated with the video content and available for purchase by user 104, and information regarding each of the available products (e.g., picture of the product, brand, price, available sizes, available styles, etc.).

In one embodiment of the invention, integrated video content 106 is rendered to user 104 with icons and links that are selectable by user 104. Thus, as user 104 watches integrated video content 106, he or she is able to interact with the video content. As an example, without any limitation as to the method of user interaction or navigation/browsing, user 104 may push a button on a device to activate the menu browser. The device may be a television remote control, a computer system, or a handheld device that communicates with interactive module 102 via wireless technology such as Bluetooth. The device may also contain interactive module 102 such that the device detects identification tag 111 from integrated video content 106 via a wireless technology (e.g., Bluetooth) and downloads from content database 110 the content information associated with integrated video content 106 for display and interaction through the device's interactive module 102. If user 104 wants to buy a shirt that a character on a television show is wearing, he or she may move a cursor on the screen (e.g., using arrow keys of the remote control) onto the character or picture of the character being displayed or a specific product category and click “enter” on the device. A list of items associated with the character or product category is then displayed for user 104 to purchase. Alternatively, user 104 may then move the cursor onto the shirt that the character wears and click “enter” again to access information regarding the shirt, such as brand, price, color, or size. Lastly, user 104 may move the cursor to the “buy” button on the menu browser and click “enter” to move the selected product into his or her interactive “shopping cart.”

The “shopping cart” can be accessed at any time for user 104 to review the list of selected products. User 104 can select a “place order” option on the “shopping cart” such that interactive module 102 can transmit order information comprising the list of selected products, payment information and shipping information to a commerce module 112 (e.g., via network/broadcaster 108 or any other Internet or wireless communications means). In one embodiment, interactive module 102 is configured to authenticate user 104 before transmitting the order information. Authentication may be achieved through the creation of a “user account” via interactive module 102. The entry data may include, but not limited to, shipping address, credit card or banking data, demographic information, user name, password, etc. Interactive module 102 is also configured to transmit the user account data and order information via a secure communications channel (e.g., the order information is encrypted).

Commerce module 112 collects the order information and sends the order information to a seller 114 of the selected products (e.g., via network/broadcaster 108 or any other Internet or wireless communications means) to complete the purchase transaction. Specifically, commerce module 112 maintains a unique identification code for each seller 114. For each identification code, commerce module 112 maintains a separate list of the seller's products that are available for purchase by user 104. Each of the seller's products may also have a unique identification code. Commerce module 112 is configured to determine the appropriate seller 114 of a selected product by examining the identification code associated with the selected product. Thus, commerce module 112 routes order information to an appropriate seller 114 for each of the products selected by user 104. In one embodiment, the order information is stored in commerce module 112 or interactive module 102 for a period of time for user 104 or seller 114 to review previous purchases. In another embodiment, the user account data, payment information, and/or shipping information can be optionally stored in a payment database 116 located within or coupled to commerce module 112 or within a memory storage via the associated hardware coupled to interactive module 102. Thus, user 104 may not need to reenter his or her payment information and/or shipping information for subsequent purchase transactions.

According to one embodiment of the invention, instead of directly purchasing a product associated with integrated video content 106, user 104 may obtain a coupon for the product via interactive module 102. In particular, after user 104 selects a product associated with integrated video content 106, he or she can select an option on the menu browser to access coupon information. Interactive module 102 is configured to transmit, for example from interactive module 102 or from content database 110, the coupon to an email address of user 104 (which may be input by user 104 to interactive module 102 or stored locally within interactive module 102 or stored globally within a user account database in an account created by user 104) or email or text message to a handheld device of user 104 (e.g., personal digital assistant, cell phone, etc.). Using a physical wire or wireless technology such as Bluetooth, interactive module 102 is also configured to transmit the coupon information (e.g., coupon number, scanner readable bar, etc.) to a printer for directly printing out the coupon or to a handheld device of user 104 (e.g., personal digital assistant, cell phone, etc.).

Interactive module 102 is further configured to provide other interactive features to user 104. Some examples include electronic program guide, interactive gaming (multiplayer or single player), interactive voting/polling system (e.g., user 104 is polled as he or she watches a political speech, singing contest, or other contest), news, electronic mail services, Internet browser capabilities, video-on-demand, etc. Interactive module 102 may also implement parental control to limit the use of certain features by a child.

In another embodiment of the invention, based on the sales made through commerce module 112, a database may be created to maintain demographic information regarding the purchasing or browsing habits for integrated video content 106 (e.g., a particular show, commercial, film, or DVD). Sellers 114 may use this demographic information to analyze purchasing trends. And distributors of integrated video content 106 may also use this demographic information to determine the ratings for a particular television show, film, or program.

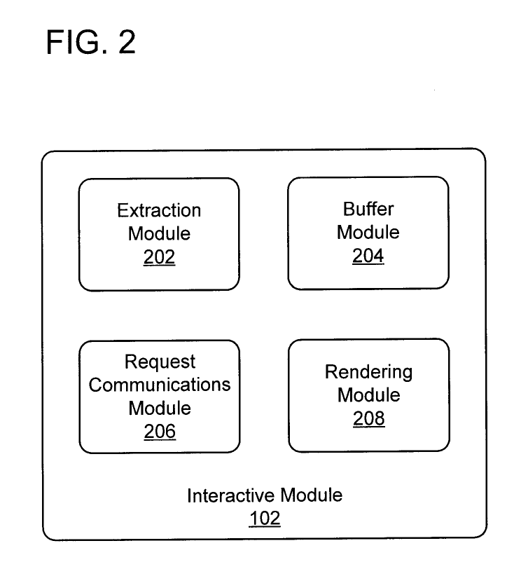

FIG. 2 illustrates a block diagram of an exemplary interactive module 102 according to one embodiment of the invention. As shown in FIG. 2, interactive module 102 includes an extraction module 202, a buffer module 204, a request communications module 206, and a rendering module 208. Extraction module 202, buffer module 204, request communications module 206, and rendering module 208 may be software, firmware, and/or hardware or any combination of software, firmware, and/or hardware. One of ordinary skill in the art will appreciate that the organization of the modules of interactive module 102 may be arranged, integrated or distributed in various ways. Various modules may be combined into one or more modules and may be distributed among different computer systems or modules.

In response to receiving integrated video content 106, extraction module 202 scans integrated video content 106 and extracts identification tag 111 from integrated video content 106. Buffer module 204 then stores the extracted identification tag 111. Request communications module 206 is configured to access the next available identification tag 111 stored in buffer module 204 and transmit the accessed identification tag 111 to content database 110. Based on identification tag 111, content database 110 searches for content information associated with integrated video content 106 and transmits the associated content information to interactive module 102. Rendering module 208 is configured to render integrated video content 106 and the associated content information to user 104.

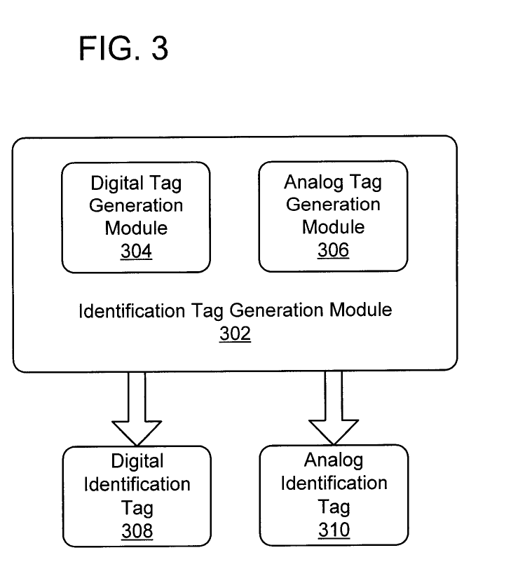

FIG. 3 illustrates a block diagram of an exemplary identification tag generation module 302 configured to generate an identification tag, according to one embodiment of the present invention. As shown in FIG. 3, identification tag generation module 302 includes a digital tag generation module 304 and an analog tag generation module 306. Identification tag generation module 302, digital tag generation module 304, and analog tag generation module 306 may be software, firmware, and/or hardware or any combination of software, firmware, and/or hardware. One of ordinary skill in the art will appreciate that the organization of the modules of identification tag generation module 302 may be arranged, integrated or distributed in various ways. Various modules may be combined into one or more modules and may be distributed among different computer systems or modules. For example, digital tag generation module 304 may be integrated with analog tag generation module 306.

According to one embodiment, digital tag generation module 304 is configured to generate a digital identification tag 308. Analog tag generation module 306 is configured to generate an analog identification tag 310. An identification tag is a generic identifier that is integrated with video content (e.g., a television show, movie, commercial, etc.) to be transmitted to interactive module 102. Each video content has a unique identification tag. In addition, content information stored in content database 110 is assigned the same identification tag as its associated video content. Therefore, content database 110 can use the identification tag to search for content information associated with a particular piece of video content. In one embodiment, content database 110 contains three separate databases: a database that contains the identity of the video content assigned to a particular identification tag; a database that contains a listing of products available for purchase by user 104, each of which having been assigned a relationship and/or association to a particular identification tag (and thus the associated video content); and a database that contains detailed information regarding each video content and the associated products.

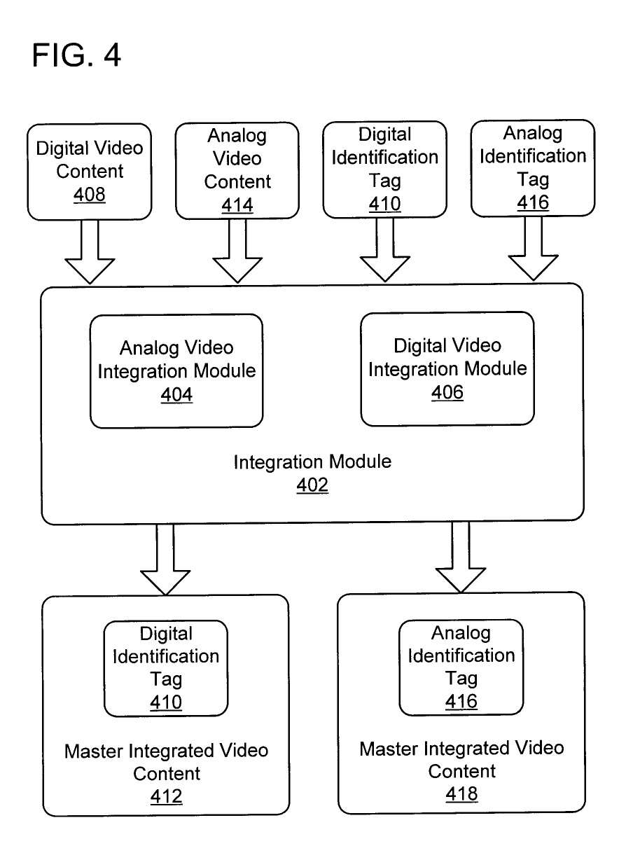

FIG. 4 illustrates a block diagram of an exemplary integration module 402 configured to integrate video content with an identification tag, according to one embodiment of the present invention. As shown in FIG. 4, integration module 402 includes an analog video integration module 404 and a digital video integration module 406. Integration module 402, analog video integration module 404 and digital video integration module 406 may be software, firmware, and/or hardware or any combination of software, firmware, and/or hardware. One of ordinary skill in the art will appreciate that the organization of the modules of integration module 402 may be arranged, integrated or distributed in various ways. Various modules may be combined into one or more modules and may be distributed among different computer systems or modules. For example, analog video integration module 404 may be integrated with digital video integration module 406.

Integration module 402 is configured to receive various video contents and identification tags via, for example, network/broadcaster 108. Specifically, integration module 402 receives digital video content 408 from a content provider (e.g., a movie production studio, broadcast station, etc.) and a digital identification tag 410 from digital tag generation module 304. Digital video content 408 may be in the form of DVD, VCD, streaming video, digital satellite, digital cable, etc. Digital video integration module 406 is configured to integrate digital identification tag 410 with digital video content 408 to generate master integrated video content 412. More specifically, digital video integration module 406 inserts digital identification tag 410 as a metadata component into digital video content 408. As a result, master integrated video content 412 is embedded with digital identification tag 410.

Integration module 402 may also receive analog video content 414 from a content provider and an analog identification tag 416 from analog tag generation module 306. Analog video content 414 may be in the form of video cassettes, over the air broadcast, or any other analogue form. In one embodiment of the invention, analog video content 414 is comprised of an audio/video signal and a vertical blanking interval (“VBI”). The VBI is the part of an analog signal that is transmitted between each video frame. For example, in North America TV (NTSC), the VBI takes up the last 45 lines of each 525-line frame. The VBI may serve the purpose of allowing a television time to reposition its electron beam from the bottom of the current video frame to the top of the next video frame. This non-viewable part of the analog signal may also be used to transmit closed-caption content.

Analog video integration module 404 is configured to integrate analog identification tag 416 with analog video content 414 to generate master integrated video content 418. More specifically, analog video integration module 404 inserts analog identification tag 416 as a VBI identification tag into the VBI portion of analog video content 414. As a result, master integrated video content 418 is embedded with analog identification tag 416.

In one embodiment of the invention, integration module 402 is further configured to convert analog video content 414 into a digital form. For example, integration module 402 is configured to change the analog audio/video signal into three components: a video component, an audio component, and an empty space component. Therefore, integration module 402 may convert analog video content 414 into a corresponding digital representation and integrate the digital representation with digital identification tag 410.

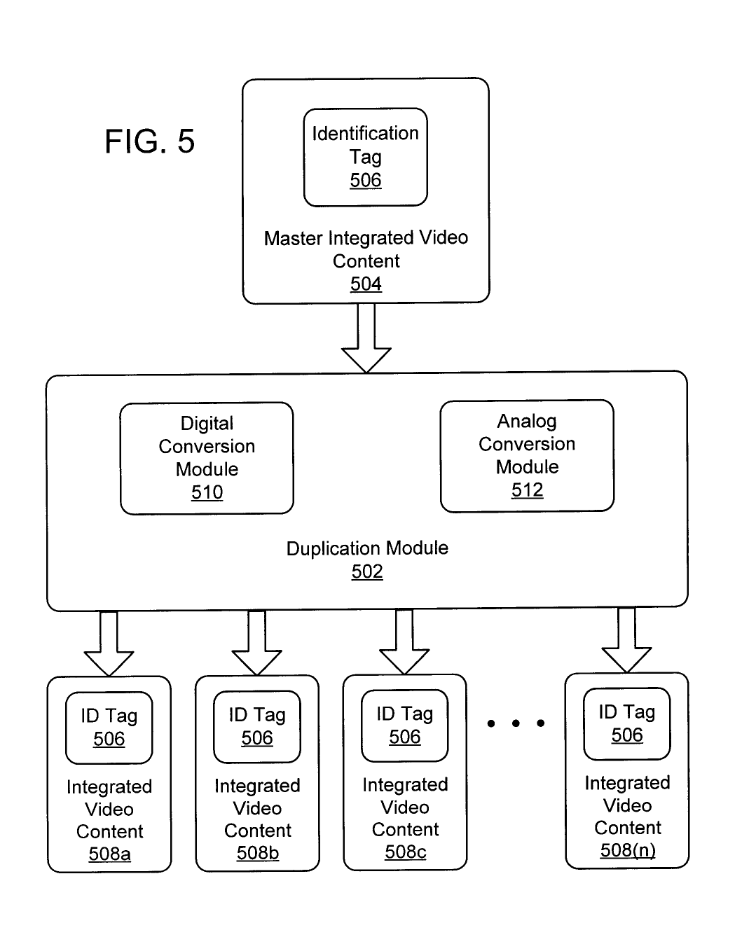

FIG. 5 illustrates a block diagram of an exemplary duplication module 502 configured to reproduce integrated video content, according to one embodiment of the invention. Duplication module 502 may be software, firmware, and/or hardware or any combination of software, firmware, and/or hardware. Duplication module 502 is configured to receive master integrated video content 504 from, for example, integration module 402. Master integrated video content 504 includes an identification tag 506. Identification tag 506 is in digital form if master integrated video content 504 is in digital form. If master integrated video content 504 is in analog form, then identification tag 506 is in analog form.

In response to receiving master integrated video content 504, duplication module 502 reproduces master integrated video content 504 into one or more integrated video contents 508a, 508b, 508c, and so on. The reproduced video contents 508 are comprised of the same video content and the same identification tag as master integrated video content 504. Thus, each reproduced video content 508 includes the same identification tag 506. The reproduced video contents 508 are then distributed to users 104 and processed by interactive modules 102. The reproduced video contents 508 may be in digital form and distributed to users 104 via streaming video, digital satellite, digital cable or as a DVD or VCD. The reproduced video contents 508 may also be in analog form and distributed to users 104 via over the air broadcast, video cassettes, or any other analogue form.

According to one embodiment of the invention, duplication module 502 includes a digital conversion module 510 and an analog conversion module 512. Digital conversion module 510 and analog conversion module 512 may be software, firmware, and/or hardware or any combination of software, firmware, and/or hardware. One of ordinary skill in the art will appreciate that the organization of the modules of duplication module 502 may be arranged, integrated or distributed in various ways. Various modules may be combined into one or more modules and may be distributed among different computer systems or modules. For example, digital conversion module 510 may be integrated with analog conversion module 512.

Digital conversion module 510 is configured to convert the analog form of master integrated video content 504 into its corresponding digital representation. For example, digital conversion module 510 is configured to change the analog audio/video signal of master integrated video content 504 into a digital video component and a digital audio component. In addition, digital conversion module 510 can convert the analog form of identification tag 506 into its corresponding digital representation.

Analog conversion module 512 is configured to convert the digital form of master integrated video content 504 into its corresponding analog representation. In this process, the digital form of identification tag 506 is also converted into its corresponding analog representation. Thus, whether master integrated video content 504 is in a digital format or in an analog format, duplication module 502 is able to reproduce master integrated video content 504 into analog video content 508 or digital video content 508.

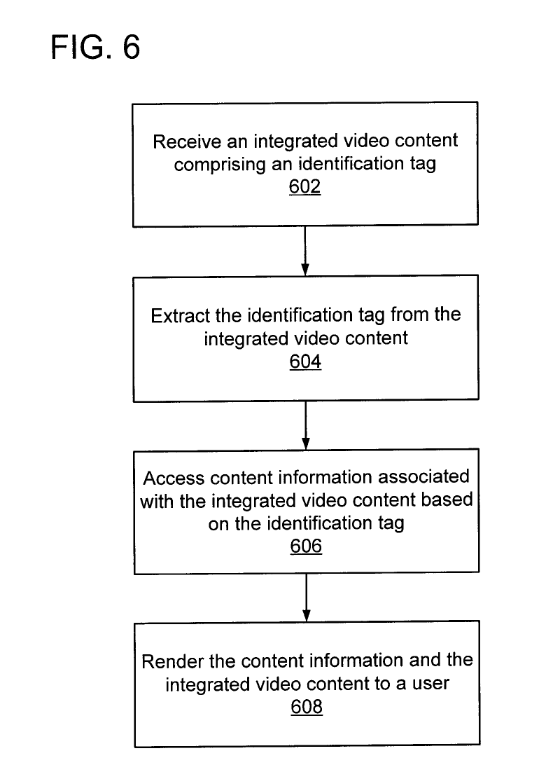

FIG. 6 illustrates a flow diagram of an exemplary process of providing interactive media content to a user, according to one embodiment. In FIG. 6, an interactive module 102 receives integrated video content 106. (602) Integrated video content 106 comprises an identification tag 111. An extraction module 202 extracts identification tag 111 from integrated video content 106. (604) A content database 110 accesses content information associated with integrated video content 106 based on identification tag 111. (606) A rendering module 208 renders the content information and integrated video content 106 to a user 104. (608)

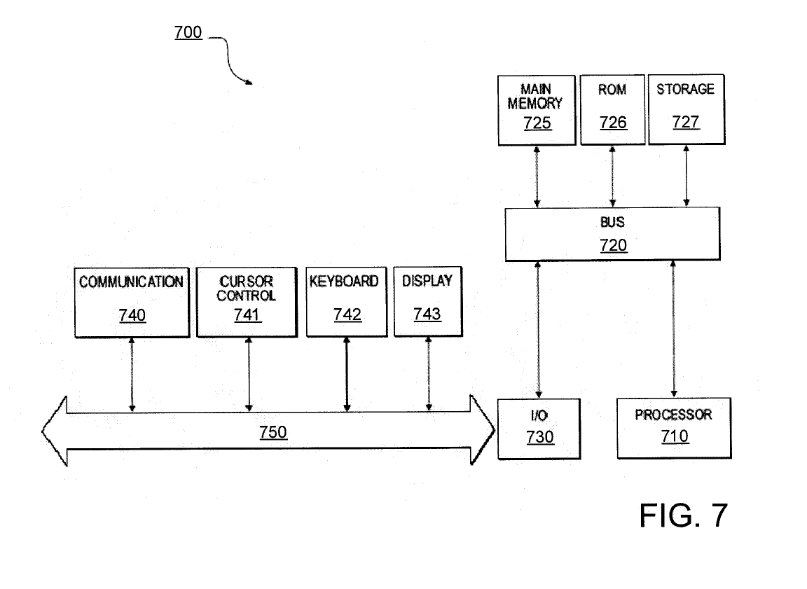

FIG. 7 illustrates an exemplary computer architecture for use with the present system, according to one embodiment. Computer architecture 700 can be used to implement the computer systems described in various embodiments of the invention, including any of the modules described herein. One embodiment of architecture 700 comprises a system bus 720 for communicating information, and a processor 710 coupled to bus 720 for processing information. Architecture 700 further comprises a random access memory (RAM) or other dynamic storage device 725 (referred to herein as main memory), coupled to bus 720 for storing information and instructions to be executed by processor 710. Main memory 725 also may be used for storing temporary variables or other intermediate information during execution of instructions by processor 710. Architecture 700 also may include a read only memory (ROM) and/or other static storage device 726 coupled to bus 720 for storing static information and instructions used by processor 710.

A data storage device 727 such as a magnetic disk or optical disc and its corresponding drive may also be coupled to computer system 700 for storing information and instructions. Architecture 700 can also be coupled to a second I/O bus 750 via an I/O interface 730. A plurality of I/O devices may be coupled to I/O bus 750, including a display device 743, an input device (e.g., an alphanumeric input device 742 and/or a cursor control device 741). For example, web pages and business related information may be presented to the user on the display device 743.

The communication device 740 is for accessing other computers (servers or clients) via a network. The communication device 740 may comprise a modem, a network interface card, a wireless network interface or other well known interface device, such as those used for coupling to Ethernet, token ring, or other types of networks.

Although the present method and system have been described in connection with an interactive media system, one of ordinary skill would understand that the techniques described may be used in any situation where it is to render video or other media content to a user.

A method and system for providing interactive media content have been disclosed. Although the present methods and systems have been described with respect to specific examples and subsystems, it will be apparent to those of ordinary skill in the art that it is not limited to these specific examples or subsystems but extends to other embodiments as well.

I claim:

1. A computer-implemented method, comprising:
receiving an integrated video content, the integrated video content comprising an identification tag;
extracting the identification tag from the integrated video content;
accessing content information associated with the integrated video content based on the identification tag; and
rendering the content information and the integrated video content to a user.

2. The computer-implemented method of claim 1, wherein the content information comprises a list of products that are available for purchase by the user.

3. The computer-implemented method of claim 2, further comprising:
receiving a purchase order from the user, the purchase indicating the selection of one or more of the products that are available for purchase by the user; and
sending the purchase order to a seller of the selected one or more products.

4. The computer-implemented method of claim 1, wherein the integrated video content is in analog form.

5. The computer-implemented method of claim 1, wherein the integrated video content is in digital form.

6. The computer-implemented method of claim 1, wherein accessing the content information comprises:
sending the identification tag to a content database, the content database maintaining the content information as a function of one or more identification tags.

7. The computer-implemented method of claim 1, wherein rendering the content information and the integrated video content to the user comprises:
rendering the content information and the integrated video content to the user via one or more of the following: digital television, analog television, video cassette, over the air transmission, streaming video, and digital versatile disc.

8. The computer-implemented method of claim 1, wherein rendering the content information and the integrated video content to the user comprises:
displaying one or more icons represented by a character of the integrated video content, wherein the one or more icons are selectable by the user; and
displaying a list of products associated with the character in response to the user selecting the one or more icons.

9. The computer-implemented method of claim 1, wherein the identification tag is unique to the integrated video content.

10. A computer-readable medium having stored thereon a plurality of instructions, said plurality of instructions when executed by a computer, cause said computer to perform: receiving an integrated video content, the integrated video content comprising an identification tag;
extracting the identification tag from the integrated video content;
accessing content information associated with the integrated video content based on the identification tag; and
rendering the content information and the integrated video content to a user.

11. The computer-readable medium of claim 10, wherein the content information comprises a list of products that are available for purchase by the user.

12. The computer-readable medium of claim 11, wherein the instructions cause the computer to perform:
receiving a purchase order from the user, the purchase indicating the selection of one or more of the products that are available for purchase by the user; and
sending the purchase order to a seller of the selected one or more products.

13. The computer-readable medium of claim 10, wherein the integrated video content is in analog form.

14. The computer-readable medium of claim 11, wherein the integrated video content is in digital form.

15. The computer-readable medium of claim 10, wherein accessing the content information comprises:
sending the identification tag to a content database, the content database maintaining the content information as a function of one or more identification tags.

16. The computer-readable medium of claim 10, wherein rendering the content information and the integrated video content to the user comprises:
rendering the content information and the integrated video content to the user via one or more of the following: digital television, analog television, video cassette, over the air transmission, streaming video, and digital versatile disc.

17. The computer-readable medium of claim 10, wherein rendering the content information and the integrated video content to the user comprises:
displaying one or more icons represented by a character of the integrated video content, wherein the one or more icons are selectable by the user; and
displaying a list of products associated with the character in response to the user selecting the one or more icons.

18. The computer-readable medium of claim 10, wherein the identification tag is unique to the integrated video content.

19. A computer system, comprising:
a processor; and
memory coupled to the processor, the memory storing instructions;
wherein the instructions when executed by the processor cause the processor to:
receive an integrated video content, the integrated video content comprising an identification tag;
extract the identification tag from the integrated video content;
access content information associated with the integrated video content based on the identification tag; and
render the content information and the integrated video content to a user.

20. The computer system of claim 19, wherein the content information comprises a list of products that are available for purchase by the user.

21. The computer system of claim 20, wherein the instructions cause the processor to:
receive a purchase order from the user, the purchase indicating the selection of one or more of the products that are available for purchase by the user; and
send the purchase order to a seller of the selected one or more products.

22. The computer system of claim 19, wherein the integrated video content is in analog form.

23. The computer system of claim 19, wherein the integrated video content is in digital form.

24. The computer system of claim 19, wherein the instructions cause the processor to:
send the identification tag to a content database, the content database maintaining the content information as a function of one or more identification tags.

25. The computer system of claim 19, wherein the instructions cause the processor to: render the content information and the integrated video content to the user via one or more of the following: digital television, analog television, video cassette, over the air transmission, streaming video, and digital versatile disc.

26. The computer system of claim 19, wherein the instructions cause the processor to:
display one or more icons represented by a character of the integrated video content, wherein the one or more icons are selectable by the user; and
display a list of products associated with the character in response to the user selecting the one or more icons.

27. The computer system of claim 19, wherein the identification tag is unique to the integrated video content.
